(19) United States
(12) Patent Application Publication
(10) Pub. No.: US 2026/0147555 A1
(43) Pub. Date: May 28, 2026

(54) UTILIZATION OF HIGH PERFORMANCE COMPUTING FOR ARTIFICAL INTELLIGENCE DRIVEN VEHICLE CUSTOMIZATION

(71) Applicant: FCA US LLC, Auburn Hills, MI (US)

(72) Inventor: Paven Kumar Mukkara Srinivas, Auburn Hills, MI (US)

(21) Appl. No.: 18/961,572

(22) Filed: Nov. 27, 2024

(51) Int. Cl. G06F 8/61; B60K 35/10; G06F 8/36

(52) U.S. Cl. CPC G06F 8/61; B60K 35/10; G06F 8/36; B60K 2360/148

(57) ABSTRACT

An artificial intelligence (AI) driven customization system for a vehicle includes an input device configured to receive a customization request from a user, the customization request relating to a feature of the vehicle and a high performance computing (HPC) controller configured to access a large language model (LLM), analyze the customization request using the LLM, based on the analysis of the customization request, obtain a software code for the customization request, and execute the obtained software code to preview a customization of the vehicle feature to the user.

### FIELD

The present application generally relates to vehicle customization and, more particularly, to techniques for utilizing high performance computing (HPC) for artificial intelligence (AI) driven vehicle customization.

### BACKGROUND

Today's customers are increasingly interested in sophisticated infotainment systems and vehicle functionality. Current vehicle systems offer limited customization, bound by the predefined options within the software, which requires the vehicle manufacturer to code each customization and store the necessary data and images. This limits the user experience to a few customization options predetermined by the manufacturer. Accordingly, while such conventional vehicle systems do work for their intended purpose, there exists an opportunity for improvement in the relevant art.

### SUMMARY

According to one example aspect of the invention, an artificial intelligence (AI) driven customization system for a vehicle is presented. In one exemplary implementation, the AI driven customization system comprises an input device configured to receive a customization request from a user, the customization request relating to a feature of the vehicle and a high performance computing (HPC) controller configured to access a large language model (LLM), analyze the customization request using the LLM, based on the analysis of the customization request, obtain a software code for the customization request, and execute the obtained software code to preview a customization of the vehicle feature to the user.

In some implementations, the HPC controller is further configured to determine whether the software code corresponding to the customization request has been previously generated. In some implementations, when the software code has been previously generated, the HPC controller is configured to obtain the software code from a local or remote memory. In some implementations, when the software code has not been previously generated, the HPC controller is configured to receive the software code from a remote software code generation service that is configured to generate the software code. In some implementations, when the software code has not been previously generated, the HPC controller is configured to generate the software code locally.

In some implementations, the customization request is a voice-based customization request from the user.

In some implementations, the HPC controller is further configured to prompt the user for an approval input or a disapproval input after executing the obtained software code to preview the customization of the vehicle feature to the user. In some implementations, the HPC controller is further configured to, in response to receiving the approval input from the user, fully integrate the obtained software code to apply the customization of the vehicle feature. In some implementations, the HPC controller is further configured to, in response to receiving the disapproval input from the user, obtain a modified or different software code for the customization request and execute the obtained modified or different software code to preview another customization of the vehicle feature to the user. In some implementations, the HPC controller is further configured to at least one of (i) reanalyze the customization request using the LLM and (ii) obtain additional information from the user relative to the customization request and analyze the additional information from the user using the LLM.

According to another example aspect of the invention, an AI driven customization method for a vehicle is presented. In one exemplary implementation, the AI driven customization method comprises receiving, by an input device of the vehicle, a customization request from a user, the customization request relating to a feature of the vehicle, accessing, by an HPC controller of the vehicle, an LLM, analyzing, by the HPC controller, the customization request using the LLM, based on the analysis of the customization request, obtaining, by the HPC controller, a software code for the customization request, and executing, by the HPC controller, the obtained software code to preview a customization of the vehicle feature to the user. In some implementations, the AI driven customization method further comprises determining, by the HPC controller, whether the software code corresponding to the customization request has been previously generated. In some implementations, when the software code has been previously generated, the software code is obtained by the HPC controller from a local or remote memory. In some implementations, when the software code has not been previously generated, the software code is received, by the HPC controller, from a remote software code generation service that is configured to generate the software code. In some implementations, when the software code has not been previously generated, the software code is generated, by the HPC controller, locally. In some implementations, the customization request is a voice-based customization request from the user.

In some implementations, the AI driven customization method further comprises prompting, by the HPC controller, the user for an approval input or a disapproval input after executing the obtained software code to preview the customization of the vehicle feature to the user. In some implementations, the AI driven customization method further comprises in response to receiving the approval input from the user, fully integrating, by the HPC controller, the obtained software code to apply the customization of the vehicle feature. In some implementations, the AI driven customization method further comprises in response to receiving the disapproval input from the user, obtaining, by the HPC controller, a modified or different software code for the customization request and executing, by the HPC controller, the obtained modified or different software code to preview another customization of the vehicle feature to the user. In some implementations, the AI driven customization method further comprises at least one of (i) reanalyzing, by the HPC controller, the customization request using the LLM and (ii) obtaining, by the HPC controller, additional information from the user relative to the customization request and analyze the additional information from the user using the LLM.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1A is a functional block diagram of a vehicle having an example artificial intelligence (AI) driven customization system according to the principles of the present application;

FIG. 1B is a functional block diagram of an example system architecture for the AI driven customization system according to the principles of the present application; and

FIG. 2 is a flow diagram of an example AI driven customization method for a feature of a vehicle according to the principles of the present application.

### DESCRIPTION

As previously discussed, Today's customers are increasingly interested in sophisticated infotainment systems and vehicle functionality. Current vehicle systems offer limited customization, bound by the predefined options within the software, which requires the vehicle manufacturer to code each customization and store the necessary data and images. This limits the user experience to a few customization options predetermined by the manufacturer. Accordingly, improved artificial intelligence (AI) driven customization systems and methods for vehicle features are presented herein.

These systems and methods leverage the newer high performance computing (HPC) vehicle controllers, which are capable of running a generative AI large language model (LLM). The LLM enables the creation and application of custom features within the vehicle's infotainment system. Examples include visual customizations (e.g., on a vehicle display) and functional customizations (e.g., customized vehicle controls/settings). The LLM could be a cloud-based or edge-based AI that designs and generates customizations (e.g., custom code for execution by the HPC vehicle controller(s). In some instances, the customization could have been previously requested and provided to another user and could then be retrieved and provided from a database without the need to regenerate the customization from scratch.

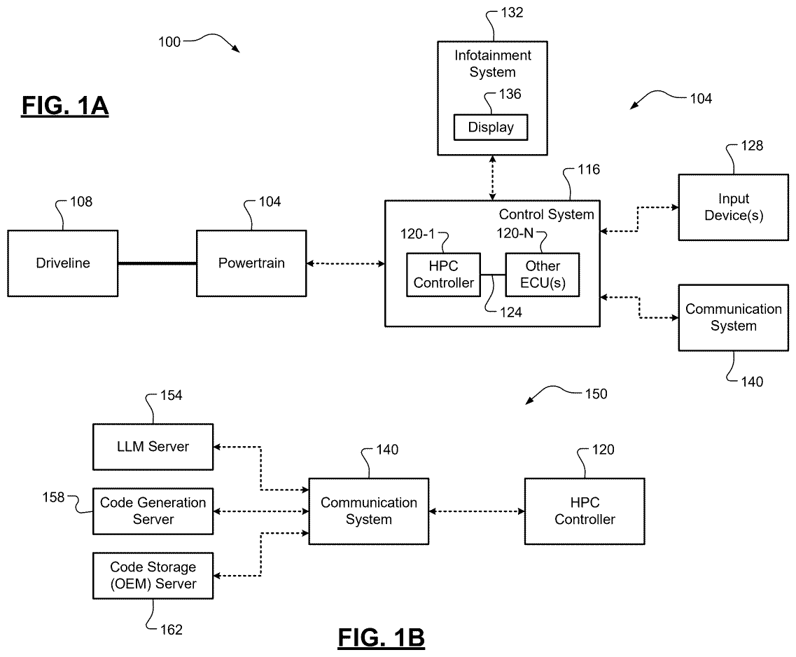

Referring now to FIGS. 1A-1B, a functional block diagram of a vehicle 100 having an example AI driven customization system 104 and an example system architecture 150 for the AI driven customization system 104 according to the principles of the present application are illustrated. The vehicle 100 generally comprises a powertrain 108 configured to generate and transfer torque to a driveline 112 for vehicle propulsion. Non-limiting examples of the component(s) of the powertrain 108 include an electric motor, an internal combustion engine, a battery system, a fuel cell system, a transmission or gear reducer, and combinations thereof.

The vehicle 100 is controlled by a control system 116, which typically includes a plurality of electronic control units (ECUs) 120-1 . . . 120-N (N being an integer greater than one; collectively, “ECUs 120”) connected and in communication via a controller area network (CAN) or similar network 120. At least one of these ECUs 120 is a HPC controller or ECU. The terms “high performance computing” and “HPC” as used herein refer to control devices including multiple processors, processor cores or multiple types or processors (central processing units, or CPUs, graphical processing units, or GPUs, and/or neural processing units, or NPUs) as well as substantial dynamic memory. Examples of these vehicle HPC controllers or ECUs include supervisory controllers or ECUs (an electrified vehicle control unit, or EVCU, a hybrid control processor, or HPC, etc.) and edge or zone controllers or ECUs, such as for advanced driver-assistance (ADAS) and autonomous driving features.

The control system 116, also referred to for purposes of this application as “HPC controller 120,” is configured to receive input from a user associated with the vehicle 100 (a driver, a passenger, etc.) via an input device 128. The input device 128 could be a voice-based system (e.g., a microphone), but it will be appreciated that the input device 128 could receive other types or multiple types of user input (voice, touch, etc.). For example, the input device 128 could be part of a display 136 (e.g., a touch display) of an infotainment system 132 of the vehicle 100. The display 136 is configured to display various different user interfaces (colors, patterns, etc.) to the vehicle user(s).

The HPC controller 120 is also configured to communicate with other remote systems via a communication transceiver or system 140 (e.g., a cellular or satellite transceiver). As shown in the example system architecture 150 of FIG. 1B, these remote systems can include an LLM server 154 where at least a portion of the LLM model utilized by the techniques of the present application is stored. In some instances, the LLM could be stored and executed locally at the HPC controller 120. The remote systems can also include a code generation service or server 158 where software code that has not been previously generated could be generated in response to a customization request from the HPC controller 120. The remote systems could also include a remote storage system or server 162 where previously generated software code could be stored for quick and subsequent retrieval (e.g., by other vehicles associated with a same original equipment manufacturer or OEM). It will be appreciated that these remote servers 154-162 could also be combined into one or more single servers.

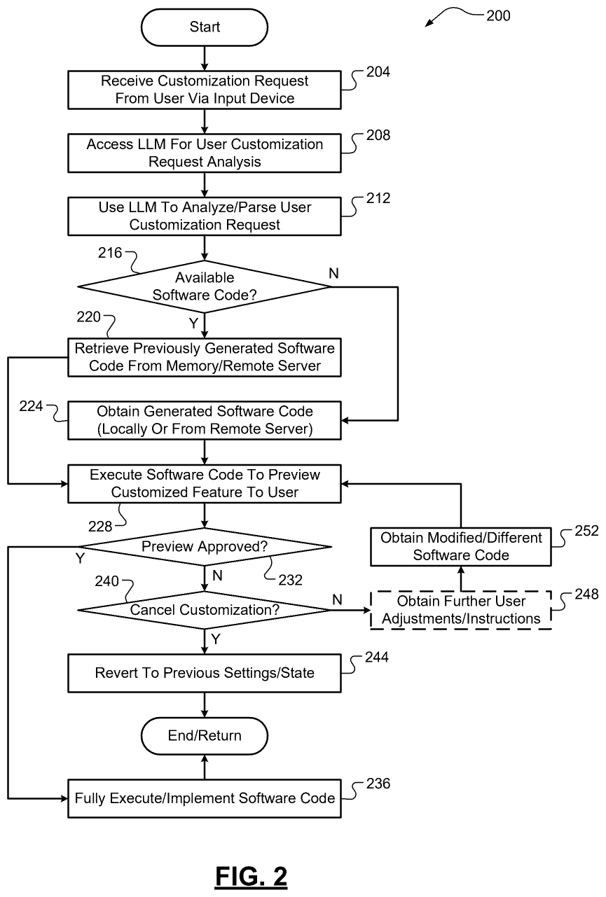

Referring now to FIG. 2 and with continued reference to FIGS. 1A-1B, a flow diagram of an example AI driven customization method for a feature of a vehicle according to the principles of the present application is illustrated. While the method 200 specifically references the vehicle 100 and its components for descriptive/illustrative purposes, it will be appreciated that the method 200 could be applicable to any suitably configured vehicle (e.g., a vehicle having at least one HPC controller and the capability for communication with the requisite remote systems). The method 200 begins at 204 where the input device 128 of the vehicle 100 receives a customization request from a user (the driver, a passenger, etc.). This customization request could be, for example, a voice-based request, but it will be appreciated that other non-voice (e.g., touch input) based customization requests could be utilized.

For example only, the customization request could be a visual customization request such as “I want the display background to be Italian tri-color.” Such a visual customization request is intended to prompt the AI driven customization system 104 to generate image(s) or a full user interface with the colors of the Italian flag (red, green, and white) for display (e.g., on display 136). Alternatively, for example only, the customization request could be a functional customization request such as “I want a custom button that, when pressed, should automatically adjust the cabin temperature to 68 degrees Fahrenheit and set the vehicle mode to Sport.” Such a functional customization request is intended to prompt the AI customization system 104 to generate a custom button (e.g., on a user interface of the display 136) that is linked to these already available functions (temperature control and vehicle drive/mode control). It will be appreciated that these are merely examples and do not intend to limit the scope of the techniques.

Upon receiving the customization request at 204, the HPC controller 120 acts as a generative AI agent to interpret the customization request and breaks it down into executable steps at 208-212. This includes the HPC controller 120 accessing a LLM (locally, remotely, or some combination thereof) and utilizing the LLM to analyze and parse the customization request at. Based on this analysis at 208, the HPC controller 120 then acts as a planner agent to determine how to accomplish each step at 212, which could include utilizing pre-configured or previously generated software code (e.g., plug-ins) such as image/user interface and button generators.

If a requested plug-in is available (e.g., previously generated and stored locally or remotely at server 162) at 216, the software code for the plug-in is quickly retrieved at 220 without the need for software code generation. If the requested plug-in is not available, the method 200 proceeds to 224 where a coder agent (locally, remotely, or some combination thereof) writes the necessary software code. As mentioned, this process can be executed either in the cloud (at server 158) or on the device (HPC controller 120). The retrieved or generated software code is sent to an executor agent within the HPC controller 120, which executes the code and presents a preview to the user at 228.

If the user approves the preview (e.g., via an approval input, which could be voice-based or touch-based) at 232, the software code is fully applied or implemented at the vehicle 100 at 236 and the method 200 then ends. If the user does not approve of the preview (e.g., via a disapproval input, which could be voice-based or touch-based), however, further steps could be potentially be performed as shown in FIG. 2 and as more fully explained below.

If the customization operation is canceled by the user at 240, the software code is not fully implemented and the HPC controller 120 reverts to the original settings at 244 and the method 200 ends. If the customization operation is not canceled by the user at 236, the method 200 proceeds to optional 248 where adjustments or modifications could be performed by the user via further instructions or requests at the input device 128 (e.g., “I want the display background to only be red and white and not green” or “I want the cabin temperature for the button to be 65 degrees Fahrenheit). At 252, the HPC controller 120 can obtain a modified or different software code, which could be based on the optional user adjustment/instructions at 248 or could be based on a slightly different analysis of the original customization request using the LLM (e.g., a next-best possible parse or interpretation of the user input). The method 200 could then return to 228 where the executor agent in the HPC controller 120 executes the modified or different software code for another preview to the user.

There could also be safety guardrails and restricted items to consider. To ensure the integrity of the vehicle's systems and user safety, the AI driven customization system 104 operates within defined boundaries. That is, specific safety guardrails are put in place to restrict the AI's operational scope to designated regions of the codebase, preventing any modifications to critical software components. This approach maintains the system's robustness while allowing for a degree of flexibility and customization. There could also be task complexity and resource management to consider. The AI driven customization system 104 is designed to manage resources efficiently, especially when dealing with complex tasks that require significant computational power. In such cases, the generative AI could utilize the HPC controller 120 during periods when the vehicle 100 is not in use, such as when parked and turned off. This ensures that the customization process does not interfere with the vehicle's primary driving functions and optimizes the use of available computing resources.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An artificial intelligence (AI) driven customization system for a vehicle, the AI driven customization system comprising:
an input device configured to receive a customization request from a user, the customization request relating to a feature of the vehicle; and
a high performance computing (HPC) controller configured to:
access a large language model (LLM);
analyze the customization request using the LLM;
based on the analysis of the customization request, obtain a software code for the customization request; and
execute the obtained software code to preview a customization of the vehicle feature to the user.

2. The AI driven customization system of claim 1, wherein the HPC controller is further configured to determine whether the software code corresponding to the customization request has been previously generated.

3. The AI driven customization system of claim 2, wherein when the software code has been previously generated, the HPC controller is configured to obtain the software code from a local or remote memory.

4. The AI driven customization system of claim 2, wherein when the software code has not been previously generated, the HPC controller is configured to receive the software code from a remote software code generation service that is configured to generate the software code.

5. The AI driven customization system of claim 2, wherein when the software code has not been previously generated, the HPC controller is configured to generate the software code locally.

6. The AI driven customization system of claim 1, wherein the customization request is a voice-based customization request from the user.

7. The AI driven customization system of claim 1, wherein the HPC controller is further configured to prompt the user for an approval input or a disapproval input after executing the obtained software code to preview the customization of the vehicle feature to the user.

8. The AI driven customization system of claim 1, wherein the HPC controller is further configured to, in response to receiving the approval input from the user, fully integrate the obtained software code to apply the customization of the vehicle feature.

9. The AI driven customization system of claim 8, wherein the HPC controller is further configured to, in response to receiving the disapproval input from the user, obtain a modified or different software code for the customization request and execute the obtained modified or different software code to preview another customization of the vehicle feature to the user.

10. The AI driven customization system of claim 9, wherein the HPC controller is further configured to at least one of (i) reanalyze the customization request using the LLM and (ii) obtain additional information from the user relative to the customization request and analyze the additional information from the user using the LLM.

11. An artificial intelligence (AI) driven customization method for a vehicle, the AI driven customization method comprising:
receiving, by an input device of the vehicle, a customization request from a user, the customization request relating to a feature of the vehicle;
accessing, by a high performance computing (HPC) controller of the vehicle, a large language model (LLM);
analyzing, by the HPC controller, the customization request using the LLM;
based on the analysis of the customization request, obtaining, by the HPC controller, a software code for the customization request; and
executing, by the HPC controller, the obtained software code to preview a customization of the vehicle feature to the user.

12. The AI driven customization method of claim 11, further comprising determining, by the HPC controller, whether the software code corresponding to the customization request has been previously generated.

13. The AI driven customization method of claim 12, wherein when the software code has been previously generated, the software code is obtained by the HPC controller from a local or remote memory.

14. The AI driven customization method of claim 12, wherein when the software code has not been previously generated, the software code is received, by the HPC controller, from a remote software code generation service that is configured to generate the software code.

15. The AI driven customization method of claim 12, wherein when the software code has not been previously generated, the software code is generated, by the HPC controller, locally.

16. The AI driven customization method of claim 11, wherein the customization request is a voice-based customization request from the user.

17. The AI driven customization method of claim 11, further comprising prompting, by the HPC controller, the user for an approval input or a disapproval input after executing the obtained software code to preview the customization of the vehicle feature to the user.

18. The AI driven customization method of claim 11, further comprising in response to receiving the approval input from the user, fully integrating, by the HPC controller, the obtained software code to apply the customization of the vehicle feature.

19. The AI driven customization method of claim 18, further comprising in response to receiving the disapproval input from the user, obtaining, by the HPC controller, a modified or different software code for the customization request and executing, by the HPC controller, the obtained modified or different software code to preview another customization of the vehicle feature to the user.

20. The AI driven customization method of claim 19, further comprising at least one of (i) reanalyzing, by the HPC controller, the customization request using the LLM and (ii) obtaining, by the HPC controller, additional information from the user relative to the customization request and analyze the additional information from the user using the LLM.
